(19) United States
(12) Patent Application Publication
(10) Pub. No.: US 2013/0159047 A1
(43) Pub. Date: Jun. 20, 2013

(54) DYNAMIC BUSINESS SCENARIO KEY PERFORMANCE INDICATOR DEFINITIONS, REAL TIME CALCULATIONS, AND ANALYSIS

(71) Applicants: Jochen Mayerle, Flein (DE); Holger Knospe, Wiesloch (DE); Marianne Brosche, Heldelberg (DE); Joachim Fessler, Grafenberg (DE); Michael Picht, Walldorf (DE); Johan Christiaan Peters, Sankt Leon-Rot (DE); Ulrich Keil, Heidelberg (DE)

(72) Inventors: Jochen Mayerle, Flein (DE); Holger Knospe, Wiesloch (DE); Marianne Brosche, Heldelberg (DE); Joachim Fessler, Grafenberg (DE); Michael Picht, Walldorf (DE); Johan Christiaan Peters, Sankt Leon-Rot (DE); Ulrich Keil, Heidelberg (DE)

(21) Appl. No.: 13/326,075

(22) Filed: Dec. 14, 2011

(51) Int. Cl. G06Q 10/06

(52) U.S. Cl. 705/7.27

(57) ABSTRACT

A selection by a user of a first business process feature defining a starting point and a second business process feature defining an end point of a requested key performance indicator calculation can be received and a set of business objects related to a plurality of business process features that impact calculation of the requested key performance indicator can be determined based on the start point and the end point and on a meta-model of each of the related business process features. An algorithm for making the requested key performance indicator calculation can be generated based on metadata from retrieved from the meta-models, and transaction data can be retrieved from instances of business objects matching limiting criteria. A value for the requested key performance indicator calculation can be calculated based on the algorithm and the retrieved transaction data.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-761F01US/2011P00163US, 34874-763F01US/2011P00166US, 34874-764F01US/2011P00167US, 34874-765F01US/2011P00168US, 34874-768F01US/2011P00171US, 34874-769F01US/2011P00172US, 34874-770F01US/2011P00173US, 34874-771F01US/2011P00174US, 34874-772F01US/2011P00175US, 34874-773F01US/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

Business processes are the foundation of many business organizations, particularly those that make use of business software architectures, such as for example enterprise resource planning (ERP) systems, and the like. A business scenario can be tailored to a specific business organization by integrating a set of business processes in a defined manner. The efficiency with which business processes are executed can have an important effect on the profitability and hence on the success of an enterprise, regardless of its size or industry. Therefore, the goal of any enterprise is to continuously measure, analyze and optimize the performance of business process execution. However, while a conceptual definition of a KPI is within the capabilities of a typical, non-technical business user, administrator, or the like, such users often lack the technical knowledge to program the necessary calculations into a complicated business software architecture.

### SUMMARY

In one aspect, a method includes receiving a selection by a user of a first business process feature defining a starting point and a second business process feature defining an end point of a requested key performance indicator calculation via a graphical representation of an organization's business configuration. A set of business objects related to a plurality of business process features that impact calculation of the requested key performance indicator is determined based on the start point and the end point and on a meta-model of each of the related business process features. An algorithm for making the requested key performance indicator calculation is generated based on metadata from retrieved from the meta-models of each of the related business process features. Transaction data is retrieved from instances of a set of business objects matching at least one limiting criteria, and a value is calculated for the requested key performance indicator calculation based on the algorithm and the retrieved transaction data.

In some variations one or more of the following features can optionally be included in any feasible combination. The business object instances and the meta-models can optionally be maintained in active system memory using a high performance in-memory database. The graphical representation of the organization's business configuration can optionally include at least one of a scenario landscape overview map showing relationships between a plurality of business scenarios in a current business configuration of the organization and a linear single scenario view. The selection can optionally include a user interaction with at least one first user interface element and at least one second user interface element of the scenario landscape overview map and/or the linear single scenario view. The first user interface element can optionally correspond to the first business process feature and the second user interface element can optionally correspond to the second business process feature. The at least one limiting criteria can optionally include at least one of a time period, a user, and a department or division of the organization. The at least one criteria can optionally be obtained as a parameter that is at least one of pre-defined, entered by a user, and set as a default parameter.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, business users can make use of a scenario or process browser visualization tool, which can optionally be based on a transit map format as discussed on one or more of the related applications, for dynamic definition of a business process performance key performance indicator (KPI). Using a scenario or process browser in this manner can allow business users to create KPI definitions in real time without assistance from IT experts. Additionally, implementations of the current subject matter can eliminate or at least reduce the need to replicate transactional business system architecture data into a data warehouse or the like in order to perform ex-post business process performance analysis. This approach can provide benefits in that it is no longer necessary to perform complex business process performance KPI definition, calculations, and analyses using replicated data.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a screenshot of a user interface illustrating a scenario-centric business scenario landscape overview view;

FIG. 2 shows another screenshot of a user interface illustrating a linear single business scenario view;

FIG. 3 is a process flow diagram illustrating aspects of a method having one or more features consistent with implementations of the current subject matter;

FIG. 4 is a diagram illustrating aspects of a system showing features consistent with implementations of the current subject matter;

FIG. 5 is a diagram illustrating aspects of a system showing features consistent with implementations of the current subject matter; and

FIG. 6 is a diagram illustrating a data repository showing features consistent with implementations of the current subject matter.

When practical, similar reference numbers denote similar structures, features, or elements.

### DETAILED DESCRIPTION

Existing solutions generally are not capable of allowing a business user to define and adjust key performance indicators (KPIs) for business scenarios and processes dynamically in order to measure the throughput times within a specific business process feature, or the overall throughput time of an end-to-end business scenario. Similarly, tools are generally lacking for determining which business processes, business process variants, business process features, etc. are executed in an by an organization and/or and how often or efficiently such business processes, business process variants, business process features, etc. are executed in day-to-day business. Users may also lack an ability to easily visualize alternate routes or business process or business scenario definitions that might improve efficiency, speed, resource consumption, throughput, safety, etc. Business process execution benchmarking across comparable organizations, divisions, departments, etc. can also be challenging and time consuming. Real-time or near real time results are difficult to come by, which can hinder the ability to perform detailed sensitivity analyses based on a series of potential changes to existing business scenarios in an organization's business configuration. It can also be desirable, and yet not convenient using currently available tools, to be able to determine an extent to which resources are currently utilized within an organization, whether existing business scenarios and/or processes in the business configuration include unproductive wait times, how often such wait times occur, and where in the various business scenarios and processes are the most significant bottlenecks restricting more efficient business operations.

To address these and potentially other issues with currently available solutions, methods, systems, articles of manufacture, and the like consistent with one or more implementations of the current subject matter can, among other possible advantages, provide the ability to define, measure, visualize and analyze scenario and process performance KPIs dynamically by selecting (e.g. by clicking, right clicking, tapping, highlighting, tabbing, or the like) two arbitrary business process features represented by user interface features in a process browser or system landscape overview map. Doing so can dynamically create an ad hoc definition of a KPI metric for instances of the business scenario or process in the string of business process features between the two selected business processes or business process features. This approach can be performed at either a scenario browser level or on a single business scenario, in some implementations using business scenario navigation features as described in the related applications listed above. As such, to define a KPI, the business user is not required to have a deep knowledge of the underlying process metrics or the scenario or process model. Merely selecting icons or other user interface features representing two business processes or business process features within a scenario browser view or a single scenario navigation view can be sufficient to access the underlying business process or business process feature definition in a business process meta-model supporting the relevant business process or business processes, and to calculate a value for the KPI over a specified interval (e.g. time, a number of completed business process instances, etc.). An illustrative analogy this functionality can be use of a voltage meter to measure a voltage between two metering points in an electrical circuit.

Business users, who are generally the members of an organization who have the most complete, practical, etc. understanding of the organization's business and business needs, while often lacking the technical skills necessary to code in a new KPI definition, to define relevant business process performance KPIs in an easy and fast way. Real-time measurement of performance-critical process KPIs can be supported to identity bottlenecks or other points or sections of inefficiency in the current business configuration of the organization. An intuitive visualization of business process performance can be provided along business scenarios or business processes as defined and illustrated in a convenient and intuitive format, thereby forming a readily accessible foundation for real-time business scenario and/or business process optimization and decision making; for business scenario and/or business process performance benchmarking (e.g. across departments, divisions, etc.); for optimizing the utilization of resources within an organization, optionally in real-time; and for speeding operational KPI calculation execution times by avoiding time-, CPU- and storage space-consuming replication of transactional data.

A scenario landscape for an organization can refer to a set including all or some of the business scenarios and/or business processes characterizing an organization's operations. In general a business scenario can includes one or more business processes, process steps, or other business process features. Business process features can include, but are not limited to, one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

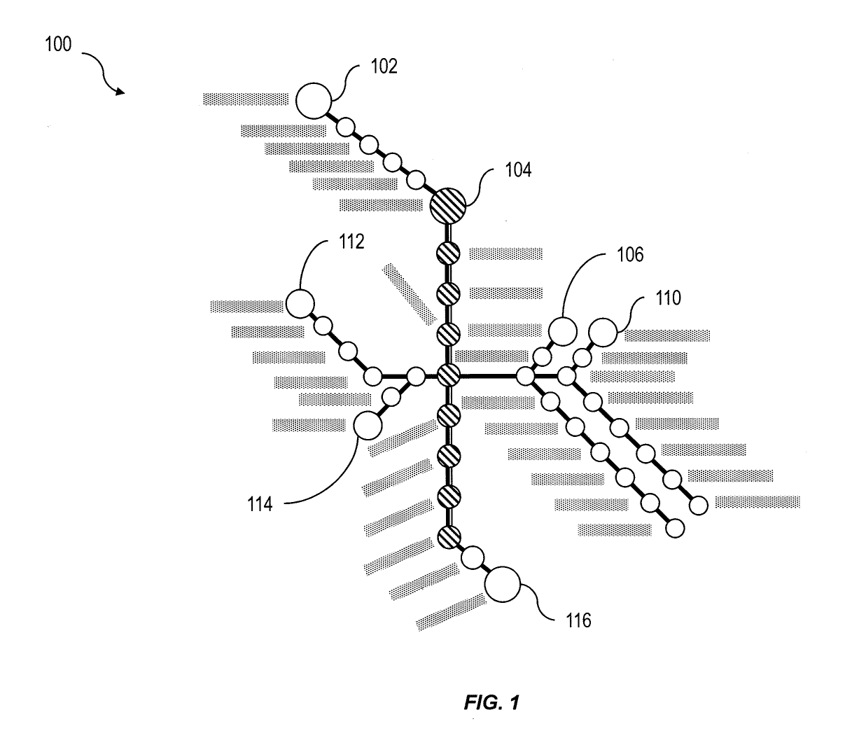

FIG. 1 illustrates an example of a scenario landscape overview map or process browser 100, which includes relational links between a plurality of business scenarios each including one or more business processes in a scenario landscape. Each of several business scenarios 102, 104, 106, 110, 112, 114, 116 are shown at a linear overview degree of detail to depict the relationships between the different business scenarios 102, 104, 106, 110, 112, 114, 116 in the scenario landscape. In an implementation, the scenario landscape overview map 100 can be modeled as a transit map that shows the place and the function of each business scenario in the scenario landscape as a whole. Intrinsic relationship types between the business scenarios 102, 104, 106, 110, 112, 114, 116 and their constituent business processes can include, but are not limited to, a predecessor scenario or process, which is defined as a business scenario or business process whose completion is a prerequisite to another business scenario or business process (e.g. business scenario 102, which includes several business processes shown in FIG. 1 as smaller circles, that leads to the initiation of business scenario 104); a successor scenario or process, which is defined as a business scenario or business process having a predecessor process or scenario (e.g. business scenario 104, which has business scenario 102 as its predecessor scenario); a joint use scenario, which is defined as a business scenario that shares a common business process, a common process step, a common data object, a common responsible entity (e.g. a person, a unit, etc.), a common event, or the like (e.g. business scenarios 106 and 110, which share process processes with business scenario 112; or business scenario 116 and business scenario 104, which share a common business process); and a hierarchical use scenario, which is defined as a business scenario that uses another business scenario as an included business process (e.g. business scenario 112, which includes as a branching business scenario 114). Also as shown in FIG. 1, one or more of the business scenarios, the included business processes, and optionally their process steps can be labeled in a manner similar to stops on a transit map.

The scenario landscape overview map 100 can advantageously be arranged in a scenario-centric manner, for example such that a selected business scenario 104 is arranged approximately centrally in the overview diagram with other business scenarios (e.g. including but not limited to the business scenario or process relationships explained in the preceding paragraph) relating to the selected business scenario 104 shown branching or intersecting with the selected business scenario 104. The selected business scenario 104 can optionally be a business scenario that is most relevant to a current role of a user, a currently active business scenario, or the like. The process overview map 100 can also advantageously include one or more visual cues to indicate information about the various business scenarios and/or the business processes shown in the process overview map 100. For example, the route line 120 of the selected business scenario 104 can be shown in a different thickness, with a different pattern, in a different color or brightness, or the like, and the business processes included in the selected business scenario 104 can likewise be shown with a different pattern, color, brightness, etc. Clicking on a process step of the selected business scenario 104 can directly navigate a user to a linear single scenario view of the currently active business scenario displayed simultaneously with a work space including user interface elements related to completion, monitoring, etc. of a currently active process step or other business feature. Clicking on a business process of another business scenario besides the selected business scenario 104 can cause the process overview map 100 to rearrange to show the scenario landscape with a new scenario-centric view based on the newly selected business scenario.

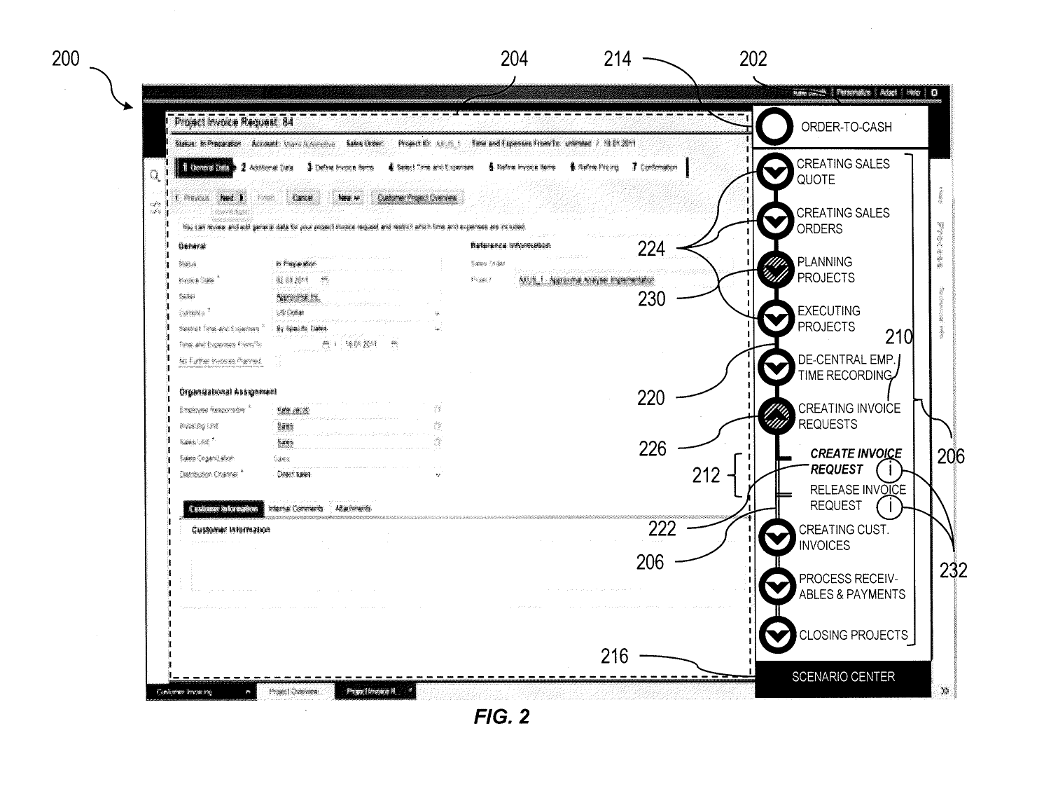

FIG. 2 illustrates an example of a linear single scenario view 200, which shows a single business scenario as a linear sequence of business process features, which can be business processes, process steps, sub-processes, tasks, activities, etc. represented by a set of first user interface features. The structure of the business scenario is condensed into a linear view, even though the actual flow of business process features necessary to complete an instance of the business scenario often involves explicit parallelism, decisions, loops, event driven changes in control flow, exceptions, and the like. Consistent with the scope of the current subject matter, any viable approach can be used to shape a business scenario into such a linear view.

As shown in FIG. 2, a scenario navigation pane 202 and a work pane 204 are concurrently displayed. A plurality of first user interface elements 206 are displayed in the scenario navigation pane 202 and arranged in a linear progression to represent the linear sequence of business process features in the scenario model of the currently actively business scenario. A first user interface element 210 corresponding to a business process 206 having additional process steps can be expanded as shown in FIG. 2 to display additional user interface elements 212 corresponding to the process steps. Also as shown in FIG. 2, the currently displayed business scenario can be identified by one or more scenario identifier user elements 214. A scenario browser user interface element 216 can link to the upper level scenario landscape overview map 100 showing a higher level view of intersections between business processes and providing links to navigate to the other processes in the scenario landscape.

The first user interface elements 206 can optionally be displayed in a manner similar to a transit route map with each business process feature within the displayed scenario being represented like a stop on the route. In this manner, a familiar visual format can rapidly convey additional information about a current context within a specific instance of the business scenario as well as status information about the various business process features along the “route” to completion of the business scenario instance. For example, a route line 220 connecting the “stops” can be presented with a first visual effect (e.g. color, brightness, shade, dots or dashes, etc.) up to the “stop” representing the business process feature that is currently “active” with related functionality being provided in the work pane 204. The currently active business process feature can be further indicated using textual or visual cues, such as for example color, shading, font, a highlighting box, etc. As a non-limiting example, the name of the business process feature displayed in conjunction with the user interface element 222 corresponding to the currently active business process feature in FIG. 2 is formatted in a bold and italicized font. A different second visual effect can be used for the route line 220 leading to the “stops” past the currently active business process feature. The icons 224 used to represent the “stops” in the scenario navigation pane can also include visual cues to inform a user about a status of one or more of the business process features, other business process feature that are included within the currently displayed business process feature user interface elements and that can be revealed by a user action to expand the route map, or the like.

Also in the example shown in FIG. 2, the expanded business process feature 210 includes process steps within a business process that are illustrated by first user elements 212 incorporated directly into the route map without branching to maintain the linear progression of the scenario model. The first user interface element 226 representing the “stop” corresponding to this business process feature 210 can include visual presentation features to indicate that it is currently expanded as shown in FIG. 2. Additional first user interface elements 232 (e.g. the “m” icons shown in FIG. 2) can provide a link to one or more additional screens displaying additional details regarding an associated business process feature.

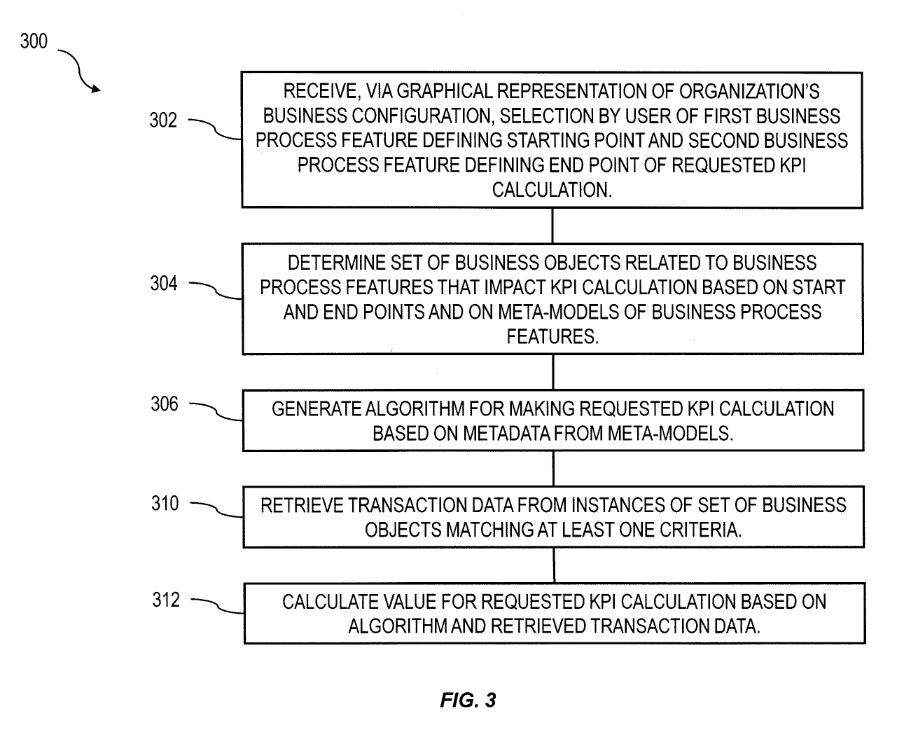

Consistent with one or more implementations of the current subject matter, a set of process navigation user interface features such as those shown in FIG. 1 and FIG. 2 can support definition of KPIs by a user via selection of any two business process features or business processes in either of a scenario landscape overview map 100 or a linear single scenario view 200. For example, a user interface can include a tab, button, other user interface element or elements, keyboard inputs, voice commands, etc. that allow a user to enter a KPI definition mode. FIG. 3 shows a process flow chart 300 illustrating a method having one or more features consistent with implementations of the current subject matter. At 302, selection by a user of a first business process feature defining a start point and second first business process feature defining an end point of a requested KPI calculation can be received, for example via a graphical representation of an organization's business configuration. The graphical representation of the organization's business configuration can optionally include a user interface displaying a scenario landscape overview map 100 or a linear single scenario view 200 (e.g. in a navigation pane 202 displayed concurrently with a work pane 204. The graphical representation of the organization's business configuration can optionally be based on a normal work user interface configuration with a “KPI definition mode” engaged (e.g. by one or more of user selection of a corresponding user interface element, a menu selection, a keyboard input, and the like). In some implementations, the user can be prompted to select the start points and end points for a KPI analysis.

The scenario landscape overview map 100 and linear single scenario view 200 are each linked to business process metadata of a business process meta-model for each business process in the organization's business configuration as well as to scenario models and other definitions of how the various business processes and other business process features are related along an instance of a business scenario or business process. Based on the selected start and end points for the KPI definition along one or more business scenarios or business processes within the business configuration, a set of business objects related to business process features that impact the requested KPI calculation can be determined at 304 using the process and scenario definitions stored in the meta-models of the selected business process features. An algorithm for making the requested KPI calculation is generated automatically based on the metadata at 306, and at 310, transaction data are retrieved from instances of the set of business objects matching at least one criteria (e.g. a time period, a user, a department, etc.). The at least one criteria can be pre-defined, entered by a user, set as a default value, or the like. A value for the KPI metric is calculated based on the algorithm and the retrieved transaction data at 312.

A process browser or scenario landscape overview map 100 can also be extended to visualize end-to-end business scenario and business scenario performance, for example of all or some of the business process features in one business scenario or business process at a single glance, to compare and analyze the dependency of business process performance from business process attributes, such as evaluation period, process stakeholders, processor, etc. In some implementations or the current subject matter, a high performance in-memory database approach (e.g. as described in one or more of the related applications) can be used to define and keep a process meta-model in active system memory so that dynamic business process performance KPI definition and analysis can occur in real time or near real time using live process and scenario instance transactional data. Using this approach can enable the performance of complex selections to associate business object instances to the corresponding process step or other business process features of a process instance, for example based on matching rules in the process model in real-time. Aggregating Throughput time of process instances can also be aggregated in real time or near real time according to the dynamic process KPI definition received via the scenario landscape overview map 100 or the linear single scenario view 200. Using insert-only capabilities of high performance in-memory technology, process lead time-based change histories can also be calculated. Insert-only capabilities refer to an approach to record updating and changing in which records are not overwritten but merely invalidated and maintained in memory while a new version is validated and an old version is invalidated but nonetheless available for analysis of the transaction data it contains.

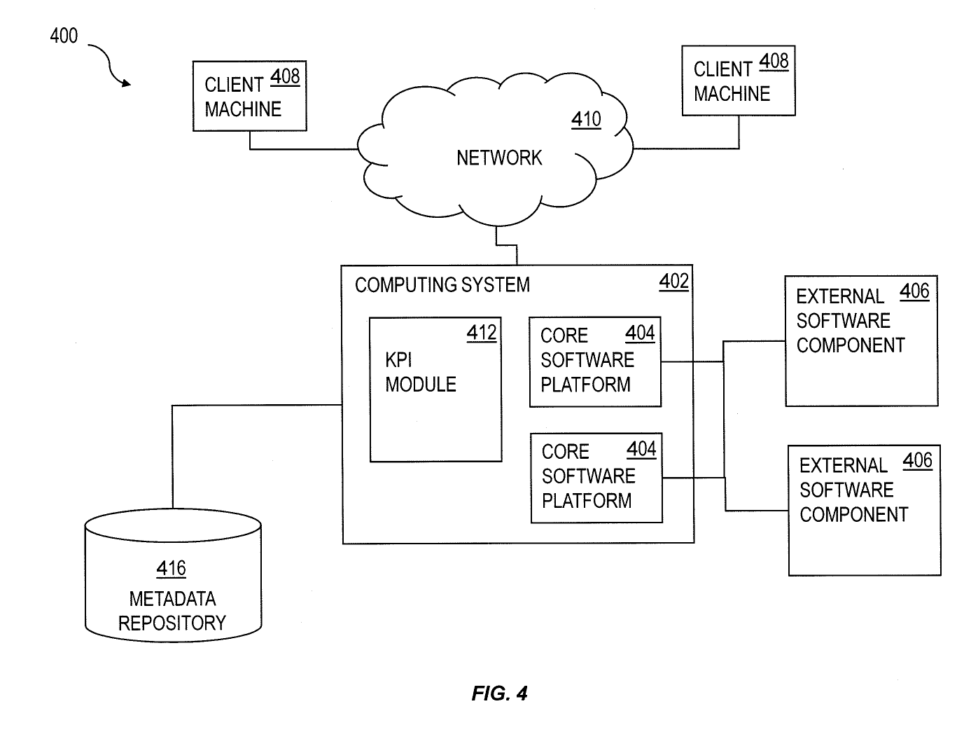

The core software platform of an ERP or other business software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 4 shows a diagram of a system consistent with such an implementation. A computing system 402 can include one or more core software platform modules 404 providing one or more features of the ERP system. The computing system can also aggregate or otherwise provide a gateway via which users can access functionality provided by one or more external software components 406, which can optionally be provided by one or more service providers external to the one or more core software platform modules 404. Client machines 408 can access the computing system, either via a direct connection, a local terminal, or over a network 410 (e.g. a local area network, a wide area network, a wireless network, the Internet, or the like). A KPI module 412 can be hosted on the computing system 402 or alternatively, on an external system accessible over a network connection. The KPI module 412 can optionally include one or more discrete software and/or hardware modules that perform operations such as those described herein.

The KPI module 412 can access one or more metadata repositories 416 and/or other data repositories that can store definitions of business scenarios, business processes, and one or more business configurations as well as data, metadata, master data, etc. relating to definitions of the business scenarios, business processes, and one or more business configurations, and/or concrete instances of the data objects (e.g. business objects) that are relevant to a specific instance of the business scenario or a business process. In some examples, the definition can optionally be stored as a business object. In some implementations, the business object can include a template definition of a standard business process. The template definition that can optionally be modified via one or more extensions that are stored in the one or more metadata repositories 416.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

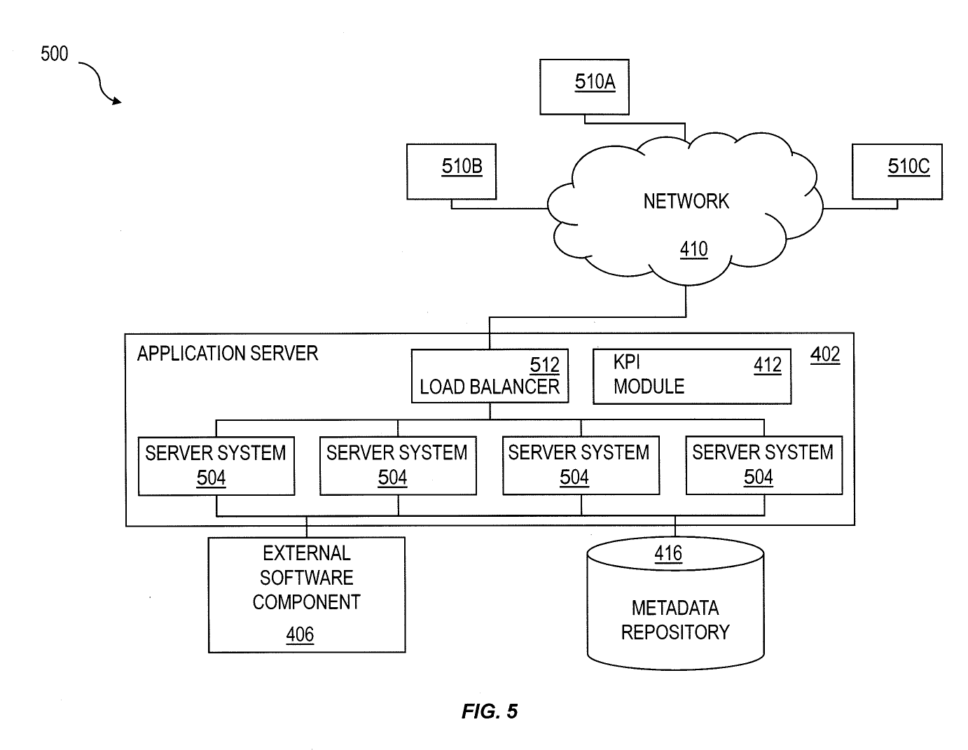

FIG. 5 shows a block diagram of a multi-tenant implementation of a software delivery architecture 500 that includes an application server 502, which can in some implementations include multiple server systems 504 that are accessible over a network 506 from client machines operated by users at each of multiple organizations 510A-510C (referred to herein as “tenants” of a multi-tenant system) supported by a single software delivery architecture 500. For a system in which the application server 502 includes multiple server systems 504, the application server can include a load balancer 512 to distribute requests and actions from users at the one or more organizations 510A-510C to the one or more server systems 504. Instances of the core software platform 404 (not shown in FIG. 5) can be executed in a distributed manner across the server systems 504. A user can access the software delivery architecture across the network using a thin client, such as for example a web browser or the like, or other portal software running on a client machine. The application server 502 can access data and data objects stored in one or more data repositories 416. The application server 502 can also serve as a middleware component via which access is provided to one or more external software components 406 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 502 that includes multiple server systems 504 that handle processing loads distributed by a load balancer 512. Potential benefits from such an arrangement can include, but are not limited to, high and reliably continuous application server availability and minimization of unplanned downtime, phased updating of the multiple server systems 504 to permit continuous availability (one server system 504 can be taken offline while the other systems continue to provide services via the load balancer 512), scalability via addition or removal of a server system 504 that is accessed via the load balancer 512, and de-coupled lifecycle processes (such as for example system maintenance, software upgrades, etc.) that enable updating of the core software independently of tenant-specific customizations implemented by individual tenants.

As in the example illustrated in FIG. 4, the metadata repository 416 can store a business object that represents a template definition of a standard business process. Each individual tenant 510A-510C can customize that standard template according to the individual business process features specific to business of the organization to which that tenant is assigned. Customizations can be stored as extensions in the metadata repository.

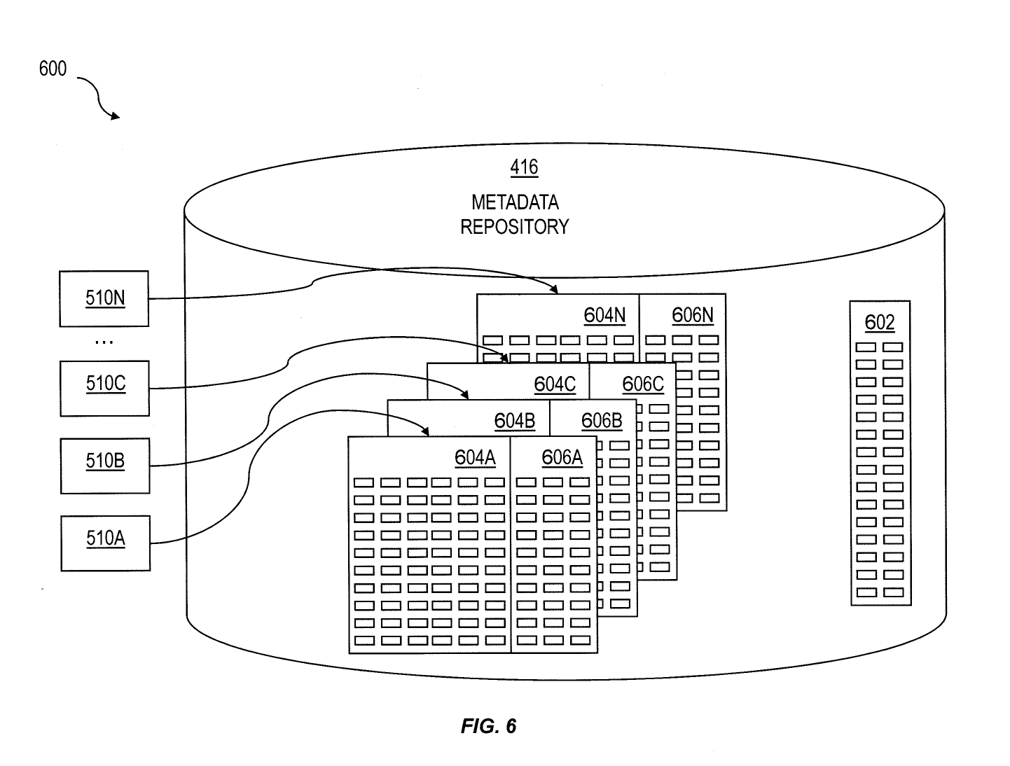

To provide for customization of the business process for each of multiple organizations supported by a single software delivery architecture 500, the data and data objects stored in the metadata repository 416 and/or other data repositories that are accessed by the application server 502 can include three types of content as shown in FIG. 6: core software platform content 602 (e.g. a standard definition of a business process), system content 604, and tenant content 606. Core software platform content 602 includes content that represents core functionality and is not modifiable by a tenant. System content 604 can in some examples be created by the runtime of the core software platform and can include core data objects that store concrete data associated with specific instances of a given business process and that are modifiable with data provided by each tenant. The data retained in these data objects are tenant-specific: for example, each tenant 510A-510N can store information about its own inventory, sales order, etc. Tenant content 606A-606N includes data objects or extensions to other data objects that are customized for one specific tenant 510A-510N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 606 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 602 and system content 604 and tenant content 606 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
receiving, via a graphical representation of an organization's business configuration, a selection by a user of a first business process feature defining a starting point and a second business process feature defining an end point of a requested key performance indicator calculation;
determining a set of business objects related to a plurality of business process features that impact calculation of the requested key performance indicator based on the start point and the end point and on a meta-model of each of the related business process features;
generating an algorithm for making the requested key performance indicator calculation based on metadata from retrieved from the meta-models of each of the related business process features;
retrieving transaction data from instances of a set of business objects matching at least one limiting criteria; and
calculating a value for the requested key performance indicator calculation based on the algorithm and the retrieved transaction data.

2. A computer program product as in claim 1, wherein the business object instances and the meta-models are maintained in active system memory using a high performance in-memory database.

3. A computer program product as in claim 1, wherein the graphical representation of the organization's business configuration comprises at least one of a scenario landscape overview map showing relationships between a plurality of business scenarios in a current business configuration of the organization and a linear single scenario view.

4. A computer program product as in claim 3, wherein the selection comprises a user interaction with at least one first user interface element and at least one second user interface element of the scenario landscape overview map and/or the linear single scenario view, the first user interface element corresponding to the first business process feature and the second user interface element corresponding to the second business process feature.

5. A computer program product as in claim 1, wherein the at least one limiting criteria comprises at least one of a time period, a user, and a department or division of the organization.

6. A computer program product as in claim 1, wherein the operations further comprise obtaining the at least one criteria as a parameter that is at least one of pre-defined, entered by a user, and set as a default parameter.

7. A system comprising:
at least one programmable processor; and
a machine-readable medium storing instructions that, when executed by the at least one processor, cause the at least one programmable processor to perform operations comprising:
receiving, via a graphical representation of an organization's business configuration, a selection by a user of a first business process feature defining a starting point and a second business process feature defining an end point of a requested key performance indicator calculation;
determining a set of business objects related to a plurality of business process features that impact calculation of the requested key performance indicator based on the start point and the end point and on a meta-model of each of the related business process features;
generating an algorithm for making the requested key performance indicator calculation based on metadata from retrieved from the meta-models of each of the related business process features;
retrieving transaction data from instances of a set of business objects matching at least one limiting criteria; and
calculating a value for the requested key performance indicator calculation based on the algorithm and the retrieved transaction data.

8. A system as in claim 7, wherein the business object instances and the meta-models are maintained in active system memory using a high performance in-memory database.

9. A system as in claim 7, wherein the graphical representation of the organization's business configuration comprises at least one of a scenario landscape overview map showing relationships between a plurality of business scenarios in a current business configuration of the organization and a linear single scenario view.

10. A system as in claim 9, wherein the selection comprises a user interaction with at least one first user interface element and at least one second user interface element of the scenario landscape overview map and/or the linear single scenario view, the first user interface element corresponding to the first business process feature and the second user interface element corresponding to the second business process feature.

11. A system as in claim 7, wherein the at least one limiting criteria comprises at least one of a time period, a user, and a department or division of the organization.

12. A system as in claim 7, wherein the operations further comprise obtaining the at least one criteria as a parameter that is at least one of pre-defined, entered by a user, and set as a default parameter.

13. A computer-implemented method comprising:
receiving, via a graphical representation of an organization's business configuration, a selection by a user of a first business process feature defining a starting point and a second business process feature defining an end point of a requested key performance indicator calculation;
determining a set of business objects related to a plurality of business process features that impact calculation of the requested key performance indicator based on the start point and the end point and on a meta-model of each of the related business process features;
generating an algorithm for making the requested key performance indicator calculation based on metadata from retrieved from the meta-models of each of the related business process features;
retrieving transaction data from instances of a set of business objects matching at least one limiting criteria; and
calculating a value for the requested key performance indicator calculation based on the algorithm and the retrieved transaction data.

14. A computer-implemented method as in claim 13, wherein the business object instances and the meta-models are maintained in active system memory using a high performance in-memory database.

15. A computer-implemented method as in claim 13, wherein the graphical representation of the organization's business configuration comprises at least one of a scenario landscape overview map showing relationships between a plurality of business scenarios in a current business configuration of the organization and a linear single scenario view.

16. A computer-implemented method as in claim 15, wherein the selection comprises a user interaction with at least one first user interface element and at least one second user interface element of the scenario landscape overview map and/or the linear single scenario view, the first user interface element corresponding to the first business process feature and the second user interface element corresponding to the second business process feature.

17. A computer-implemented method as in claim 13, wherein the at least one limiting criteria comprises at least one of a time period, a user, and a department or division of the organization.

18. A computer-implemented method as in claim 13, further comprising obtaining the at least one criteria as a parameter that is at least one of pre-defined, entered by a user, and set as a default parameter.

19. A computer-implemented method as in claim 13, wherein at least one of the receiving, the determining, the generating, the retrieving, and the calculating is performed by at least one programmable processor.
